(19) United States
(12) Patent Application Publication
(10) Pub. No.: US 2026/0364588 A1
(43) Pub. Date: Nov. 19, 2026

(54) ION EXCHANGER FILTER DEVICE AND ION EXCHANGER CARTRIDGE

(71) Applicant: MANN+HUMMEL GmbH, Ludwigsburg (DE)

(72) Inventors: Andreas WILDERMUTH, Marbach am Neckar (DE); Frank PFLÜGER, Sachsenheim (DE); Arndt-Udo ROLLE, Stuttgart (DE); Simon LEININGER, Stuttgart (DE)

(21) Appl. No.: 19/754,349

(22) Filed: Jul. 27, 2026

Related U.S. Application Data
(63) Continuation of application No. 17/894,450, filed on Aug. 24, 2022, now Pat. No. 12,728,411.
Application No. 17/894,450 is a continuation of application No. PCT/EP2021/052844, filed on Feb. 5, 2021.

(30) Foreign Application Priority Data
Feb. 24, 2020 (DE) 10 2020 104 720.7

(51) Int. Cl. B01J 47/024; H01M 8/04029; H01M 8/04044

(52) U.S. Cl. CPC B01J 47/024; H01M 8/04044; H01M 8/04029

(57) ABSTRACT

An ion exchanger filter device has a housing with an inflow opening and an outflow opening for a medium. An ion exchanger cartridge is arranged in the housing and has a cartridge container with a receptacle that is delimited by a circumferentially extending wall provided with one or more outflow ports about the circumferentially extending wall. The receptacle is filled with ion exchanger material. The outflow ports are arranged offset in an axial direction of the ion exchanger cartridge relative to the outflow opening of the housing of the ion exchanger filter device. A flow path for the medium extends from the inflow opening through the one or more outflow ports of the ion exchanger cartridge to the outflow opening. The flow path has a deflection downstream of the outflow ports from a first flow direction in the axial direction to a second flow direction opposite the first flow direction.

### CROSS-REFERENCE TO RELATED APPLICATIONS

This application is a continuation of U.S. application Ser. No. 17/894,450 having a filing date of Aug. 24, 2022, which is a continuation application of international application No. PCT/EP2021/052844 having an international filing date of Feb. 5, 2021 and designating the United States, the international application claiming a priority date of Feb. 24, 2020 based on prior filed German patent application No. 10 2020 104 720.7, the entire contents of the aforesaid applications being incorporated herein by reference to the fullest extent permissible.

### BACKGROUND

The invention concerns an ion exchanger filter device, for example for a fuel cell system, with a housing in which an ion exchanger cartridge is received, as well as an ion exchanger cartridge for an ion exchanger filter device.

Fuel cells have an electrical efficiency of approximately 50%. The remainder of the energy is retained as heat. The latter must be discharged in order to keep the efficiency of the fuel cell as high as possible. For this purpose, a cooling medium flows about the cells. In case the cooling medium is electrically conductive, short circuiting between the cells may occur. Therefore, a deionization by means of an ion exchanger is necessary. Since the cooling liquid must fulfill also further properties such as anti-freezing, mixtures are used here, e.g., deionized water and mono-ethylene glycol in a ratio of about 50:50.

DE102009012379A1 discloses an ion exchanger cartridge for a cooling agent system of a fuel cell stack with a housing that is adapted so as to contain an ion exchanger resin therein. The housing comprises an inlet and at least one medium-permeable outlet port that is configured for flow of cooling agent therethrough. The ion exchanger cartridge is adapted such that it is arranged removably in the cooling agent system. DE102009012379A1 further discloses for this purpose an ion exchanger cartridge arrangement which comprises the ion exchanger cartridge. The ion exchanger cartridge arrangement comprises a holder that is coupled with the ion exchanger cartridge. The holder is adapted for removal of the ion exchanger cartridge from the cooling agent system.

### SUMMARY

An object of the invention is to provide a service-friendly ion exchanger filter device that is advantageous regarding installation space and provided with an improved venting possibility.

A further object is to provide an ion exchanger cartridge for a service-friendly ion exchanger filter device that is advantageous regarding installation space and provided with an improved venting possibility.

The aforementioned object is solved according to an aspect of the invention by an ion exchanger filter device, for example for a fuel cell system, with a housing in which an ion exchanger cartridge is received, wherein the housing comprises at least one inflow opening and at least one outflow opening for a medium, wherein the at least one inflow opening and the at least one outflow opening penetrate a wall of the housing, wherein a flow path extends from the inflow opening through the ion exchanger cartridge to the outflow opening, wherein the ion exchanger cartridge comprises a cartridge container with a receptacle that is filled with ion exchanger material and is delimited by a circumferentially extending wall that comprises one or a plurality of outflow ports distributed at or about its circumference, wherein the outflow port or ports of the ion exchanger cartridge in relation to the outflow opening of the housing are arranged offset in axial direction, wherein the flow path downstream of the outflow ports of the ion exchanger cartridge comprises at least one deflection, for example by at least about 45°, for example by about 90°.

The further object is solved according to a further aspect of the invention by an ion exchanger cartridge for an ion exchanger filter device according to the invention, with a cartridge container that comprises a receptacle that is filled with ion exchanger material and is delimited by a circumferentially extending wall that comprises one or a plurality of outflow ports distributed at or about its circumference, wherein the wall is configured connected as one piece or with form fit or material fusion to a cover of a housing of the ion exchanger filter device for receiving the ion exchanger cartridge.

Beneficial configurations and advantages of the invention result from the following description in conjunction with the drawings.

An ion exchanger filter device is proposed, for example for a fuel cell system, with a housing in which an ion exchanger cartridge is received, wherein the housing comprises at least one inflow opening and at least one outflow opening for a medium, and wherein the at least one inflow opening and the at least one outflow opening penetrate a wall of the housing. A flow path extends from the inflow opening through the ion exchanger cartridge to the outflow opening. The ion exchanger cartridge comprises a cartridge container with a receptacle that is filled with ion exchanger material and is delimited by a circumferentially extending wall that comprises one or a plurality of outflow ports distributed at or about its circumference.

According to an embodiment, the outlet port or ports of the ion exchanger cartridge in relation to the outflow opening of the housing are arranged offset in axial direction, wherein the flow path comprises downstream of the outflow ports of the ion exchanger cartridge at least one deflection, for example by at least about 45°, for example by about 90°. The flow exits from the outflow ports substantially in radial direction in order to experience subsequently the deflection.

According to a further embodiment, the outflow opening may penetrate a jacket wall of the housing. In a further embodiment variant, the inflow opening may also penetrate a jacket wall of the housing, wherein the inflow opening alternatively may however also be provided in an end face wall.

Due to the deflection, the flow path downstream of the outflow ports extends in sections opposite to a flow path within the cartridge body.

The ion exchanger filter device may be used for deionizing water, for example, for internal combustion engines with water injection, fuel cell systems, and the like.

An improvement of the manufacturing process of the ion exchanger cartridge may be obtained by a cartridge container with insert-molded screen fabric, wherein the screen fabric may cover the inflow opening as well as the at least one outflow opening of the ion exchanger cartridge. An advantage of this design is that insert molding is required only for one component. In this context, the inflow opening ideally may extend perpendicularly to the axial direction, for example, in the bottom of the ion exchanger cartridge and the at least one outflow opening may be radially oriented in relation to the axial direction of the ion exchanger cartridge in the wall of the ion exchanger cartridge. The closure of the cartridge container filled with the ion exchanger material, for example, ion exchanger resin, may be realized directly with the cover of the housing of the ion exchanger filter device so that this component group may be reduced by one component.

This cover ensures that the ion exchanger material remains in the ion exchanger cartridge and may seal in operation also the housing against the environment.

For the ion exchanger filter device according to an embodiment, the installation space may be utilized beneficially because ion exchanger material may be arranged also above the outlet opening of the ion exchanger filter device when the ion exchanger cartridge extends in axial direction past the outflow opening. The cooling medium may then flow to the inner side of the cover where it is deflected and, via an annular gap between the cartridge container and the cover of the ion exchanger filter device, may be guided opposite to the prior flow direction back to the outflow opening.

In this context, the deflection of the flow upon entry into the annular gap may act in a homogenizing manner on the flow so that the entire ion exchanger material is used up uniformly and no dead spaces are formed with respect to the flow.

An arrangement of the outflow opening far toward the top at the housing of the ion exchanger filter device in relation to the direction of gravity may, in turn, ensure that the ion exchanger filter device is vented sufficiently well.

Moreover, the ion exchanger filter device according to an embodiment ensures that all service-relevant parts may be exchanged in one working step. This encompasses for example ion exchanger material and seals between the ion exchanger cartridge and the housing of the ion exchanger filter device.

According to an embodiment of the ion exchanger filter device, the outflow ports of the ion exchanger cartridge in relation to a direction of gravity in an intended mounting position may be arranged axially above the outflow opening of the housing. In this way, the installation space for the ion exchanger filter device may be utilized beneficially because ion exchanger material is arranged also above the outflow opening of the ion exchanger filter device. The cooling medium flows then to the inner side of the cover where it is deflected and, via an annular gap between the cartridge container and the cover of the ion exchanger filter device, is guided opposite to the prior flow direction back to the outflow opening.

According to an embodiment of the ion exchanger filter device, the outflow opening may be arranged in an upper third of a housing height of the housing. In this manner, for the arrangement of the outflow port of the ion exchanger cartridge above the outflow opening of the housing, a beneficial flow distribution as well as a beneficial flow resistance of the ion exchanger filter device may be achieved.

According to an embodiment of the ion exchanger filter device, the outflow ports of the ion exchanger cartridge may be arranged in an axially upper quarter of the receptacle. In this arrangement of the outlet ports, it is possible to utilize the ion exchanger material in the ion exchanger cartridge beneficially prior to it having to be replaced in a servicing process.

According to an embodiment of the ion exchanger filter device, screen fabric may be arranged in front of the outflow ports of the ion exchanger cartridge. The screen fabric enables a passage of the medium flow with low flow resistance and retains at the same time the ion exchanger material in the ion exchanger cartridge. The outflow ports of the cartridge container may thus be dimensioned in a beneficial size.

According to an embodiment of the ion exchanger filter device, the housing may comprise an inflow socket which may be arranged in a lower third of a housing height of the housing. The medium flow may thus be beneficially guided at the bottom of the ion exchanger cartridge through an inflow port into the cartridge container. The flow resistance may be kept low due to the low arrangement of the inflow socket.

According to an embodiment of the ion exchanger filter device, the ion exchanger cartridge may comprise at least one circumferentially extending seal, for example a circumferentially extending seal that seals substantially in radial direction, which for example is arranged at an axial end region facing away from the outlet ports. With such a circumferentially extending, radially acting seal, the ion exchanger cartridge may be effectively sealed at the lower end for intended mounting in the housing of the ion exchanger filter device so that a separation between unfiltered and filtered medium is ensured. The seal may be held at the cover, for example in a seal groove adjoining a thread section.

According to an embodiment of the ion exchanger filter device, the ion exchanger material may be present as loose fill. The loose fill, for example in the form of ion exchanger resin particles, comprises a large surface area so that the effectiveness and effective utilization of the ion exchanger material is realized and a long service life of the ion exchanger cartridge may be achieved.

According to an embodiment of the ion exchanger filter device, a cover of the housing may be embodied as one piece together with the ion exchanger cartridge or may be connected with form fit or material fusion to the cartridge container. In this manner, the ion exchanger cartridge may be produced in a cost-efficient manner. Also, an effective sealing action of the interior of the ion exchanger filter device against the environment may be realized. In this way, the separation between filtered and unfiltered medium is possible in an effective manner.

According to an embodiment of the ion exchanger filter device, the cover may comprise an overlap region, for example a connection section, for example a thread section, which in axial direction overlaps the outflow ports. The ion exchanger cartridge may be inserted with the overlap region easily into the housing and connected thereto. For example, the overlap region may have for this purpose a thread section which interacts with a counter thread arranged at the housing of the ion exchanger filter device. Due to the overlap, the outflow port may be arranged at the upper end of the receptacle of the cartridge container so that an effective utilization of the ion exchanger material is provided. The filtered medium may be guided through the outflow port in a gap between the overlap region and the wall of the cartridge container to the outflow opening of the housing.

According to a further aspect of the invention, an ion exchanger cartridge for an ion exchanger filter device is proposed, with a cartridge container that comprises a receptacle that is filled with ion exchanger material and is delimited by a circumferentially extending wall that comprises one or a plurality of outflow ports distributed at or about its circumference.

According to an embodiment, the wall is embodied as one piece together with a cover or connected with form fit or with material fusion to the cover, wherein the cover is provided as the cover of a housing of the ion exchanger filter device for receiving the ion exchanger cartridge.

An improvement of the manufacturing process of the ion exchanger cartridge may be obtained by a cartridge container with insert-molded screen fabric, wherein the screen fabric covers the inflow opening as well as the at least one outflow opening of the ion exchanger cartridge. An advantage of this design is that insert molding is required only at one component. In this context, the inflow opening is ideally oriented vertically and the at least one outflow opening is radially oriented in relation to an axial direction of the ion exchanger cartridge.

The closure of the cartridge container filled with the ion exchanger material such as, for example, ion exchanger resin, may be realized directly with the cover of the housing of the ion exchanger filter device so that this component group may be reduced by one component.

In this manner, the ion exchanger cartridge may be produced inexpensively. Also, an effective sealing action of the interior of the ion exchanger filter device against the environment may be realized. In this way, the separation between filtered and unfiltered medium is possible in an effective manner.

According to an embodiment of the ion exchanger cartridge, the cover may comprise an overlap region, for example a connection section, for example a thread section, which in axial direction at least overlaps the wall. The ion exchanger cartridge may be inserted with the overlap region easily into the housing and connected thereto. For example, the overlap region may comprise a thread section which interacts with a counter thread arranged at the housing of the ion exchanger filter device. Due to the overlap, the outflow port may be arranged at the upper end of the receptacle of the cartridge container so that an effective utilization of the ion exchanger material is provided. The filtered medium may be guided through the outlet port in a gap between the overlap region and the wall of the cartridge container to the outflow opening of the housing.

A gap, for example an annular gap, is formed between the overlap region and the wall. In an embodiment of the ion exchanger filter device, the installation space may be beneficially utilized because ion exchanger material may be arranged also above the outlet opening of the ion exchanger filter device. The cooling medium flows then to the inner side of the cover where it is deflected and guided through the annular gap between the cartridge container and the cover of the ion exchanger filter device opposite to the prior flow direction back to the outlet opening. The annular gap acts in this context in a homogenizing manner on the flow so that the entire ion exchanger material is used up uniformly and no dead spaces are formed in regard to the flow.

According to an embodiment of the ion exchanger cartridge, the outflow port or ports may be arranged in a region of the wall overlapped by the overlap region. Due to the overlap, the outflow port may be arranged at the upper end of the receptacle of the cartridge container so that an effective utilization of the ion exchanger material is provided. The filtered medium may be guided through the outflow port in a gap between the overlap region and the wall of the cartridge container to the outflow opening of the housing.

Furthermore, a flow path of a medium through the ion exchanger cartridge downstream of the outflow ports comprises at least one deflection within the gap. The deflection of the flow upon entry into the annular gap acts in this context in a homogenizing manner on the flow so that the entire ion exchanger material is used up uniformly and no dead spaces are formed in regard to the flow.

According to a further aspect of the invention, a fuel cell system with an ion exchanger filter device according to the invention is proposed. Due to the integration of the ion exchanger filter device in the fuel cell system, a compact facility is provided which may be operated cost-efficiently and service-friendly.

### BRIEF DESCRIPTION OF THE DRAWINGS

Further advantages result from the following description of the drawings, wherein embodiments of the invention are illustrated. The drawings and the description contain numerous features in combination. A person of skill in the art will consider the features expediently also individually and combine them to expedient further combinations.

FIG. 1 shows an ion exchanger filter device according to an embodiment of the invention in an isometric view.

FIG. 2 shows the longitudinally sectioned ion exchanger filter device according to FIG. 1 in a plan view.

FIG. 3 shows an ion exchanger cartridge for an ion exchanger filter device according to an embodiment of the invention.

FIG. 4 shows the ion exchanger cartridge according to FIG. 3 with partially sectioned overlap region.

### DETAIL DESCRIPTION

In the drawing figures, same or same-type components are identified with same reference characters. The drawing figures show only examples and are not to be understood as limiting.

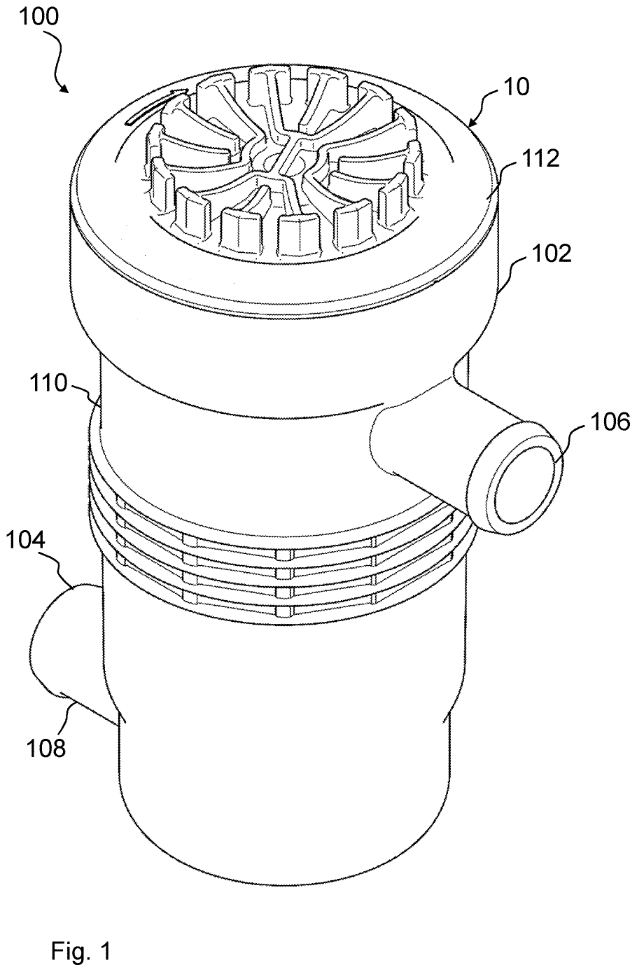

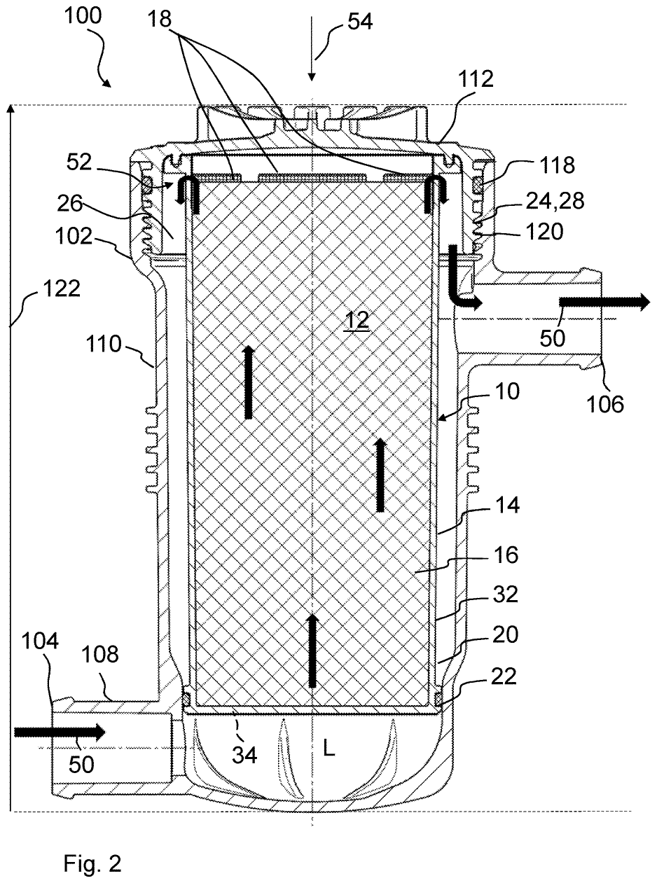

FIGS. 1 and 2 show an ion exchanger filter device 100 according to an embodiment of the invention which is provided for example for a fuel cell system. The ion exchanger filter device 100 is illustrated in FIG. 1 in an isometric view and in FIG. 2 a longitudinal section in a plan view.

The ion exchanger filter device 100 comprises a housing 102 in which an ion exchanger cartridge 10 is received. The housing 102 comprises at least one inflow opening 104 and at least one outflow opening 106 for a medium, for example, a cooling medium, wherein the at least one inflow opening 104 and the at least one outflow opening 106 penetrate a jacket wall 110 of the housing 102.

The housing 102 comprises an inflow socket 108 with the inflow opening 104 which may be arranged in a lower third of a housing height 122 of the housing 102 wherein the outflow opening 106 is arranged in an upper third of the housing height 122 of the housing 102.

A flow path 50 extends from the inflow opening 104 of the inflow socket 108 through the ion exchanger cartridge 10 to the outflow opening 106.

The ion exchanger cartridge 10 comprises a cartridge container 14 with a receptacle 16 that is filled with ion exchanger material 12 and is delimited by a circumferentially extending wall 32 that comprises a plurality of outflow ports 18 distributed about its circumference. The outflow ports 18 of the ion exchanger cartridge 10 are arranged in relation to the outflow opening 106 of the housing 102 offset in axial direction L. The outflow ports 18 in relation to a direction of gravity 54 in the illustrated intended mounting position are arranged axially above the outlet opening 106 of the housing 102.

The ion exchanger material 12 in receptacle 16 is provided as loose fill and may contain, for example, an ion exchanger resin in particle form.

Due to the arrangement of the outflow ports 18, the flow path 50 downstream of the outflow ports 18 of the ion exchanger cartridge 10 comprises a deflection 52, for example at least about 45°.

In the ion exchanger filter device 100 according to the invention, the installation space may be utilized beneficially because ion exchanger resin may be arranged also above the outlet opening 106 of the ion exchanger filter device 100.

The cooling medium flows via the inflow opening 104 of the inflow socket 108 of the housing 102 into the lower interior of the housing 102. Here, the medium may enter the cartridge container 14 via the inflow port 34, not visible in the illustration and arranged in the lower end region 20 of the cartridge container 14, and flow through the ion exchanger material 12. The medium may then flow through the outflow ports 18 to the inner side of the cover 112 where the medium is deflected and guided through an annular gap 26 between the cartridge container 14 and the cover 112 of the ion exchanger filter device 100 opposite to the prior flow direction back to the outflow opening 106 of the housing 102.

The deflection 52 of the flow upon entry into the annular gap 26 acts in this context in a homogenizing manner on the flow so that the entire ion exchanger resin is uniformly utilized and no dead spaces are formed in relation to the flow.

The arrangement of the outflow opening 106 far toward the top in relation to the direction of gravity 54 ensures, in turn, that the ion exchanger filter arrangement 100 may be vented sufficiently well.

The ion exchanger cartridge 10 comprises at the lower axial end region 20 facing away from the outlet ports 18 a circumferentially extending seal 22, for example a circumferentially extending seal that seals substantially in radial direction, which serves for sealing at the inner side of the jacket wall 110 of the housing 102.

The cover 112 of the housing 102 is embodied as one piece together with the ion exchanger cartridge 10 so that the receptacle 16 of the cartridge container 14 is sealed by the cover 112 against the environment. The cover 112 comprises an overlap region 24 which overlaps the outflow ports 18 in axial direction L. The overlap region 24 is configured as a connection section 28 with a thread section.

For intended mounting of the ion exchanger filter device, the ion exchanger cartridge 10 may be inserted with the cover 112 into the housing 102 and connected by the cover 112 to the housing 102. In this context, the thread section of the connection section 28 engages the counter thread 120 of the housing 102. A radially acting, circumferentially extending seal 118 axially above the thread of the connection region 28 is provided for sealing between the cover 112 and the housing 102.

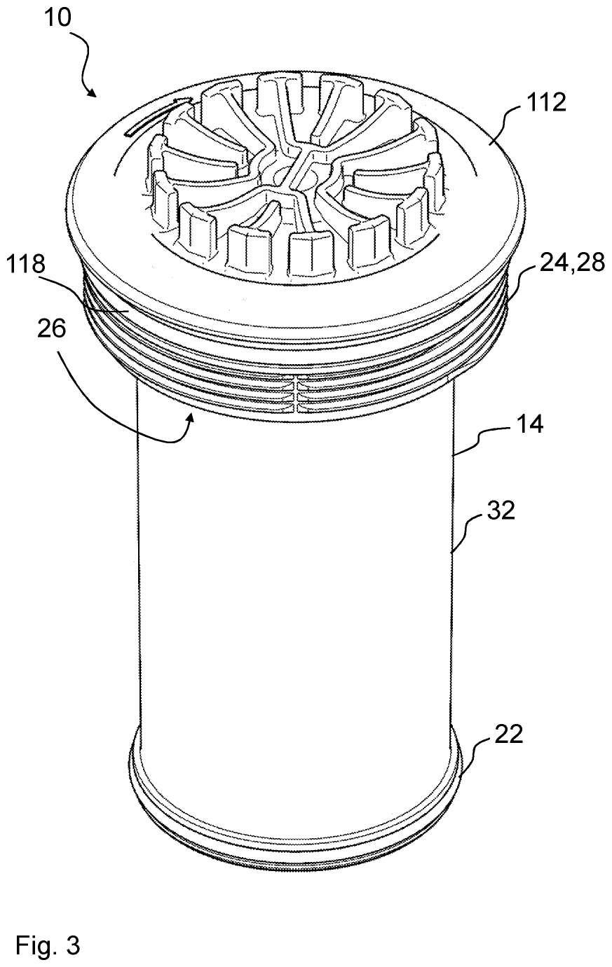

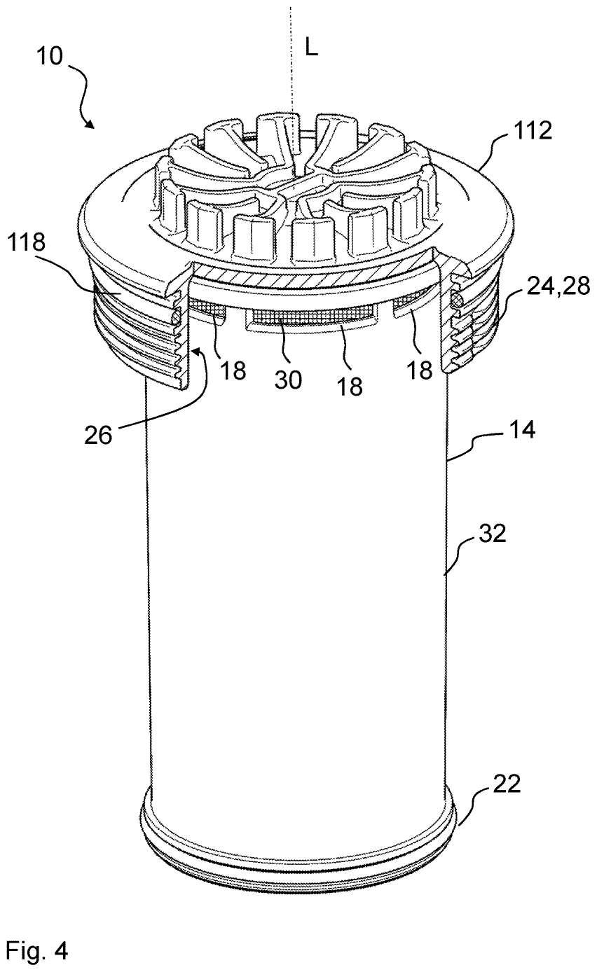

FIG. 3 shows an ion exchanger cartridge 10 for an ion exchanger filter device 100 according to an embodiment of the invention. In FIG. 4, the ion exchanger cartridge 10 according to FIG. 3 is illustrated with partially sectioned overlap region 24 so that the outflow ports 18 may be seen.

The ion exchanger cartridge 10 comprises a cartridge container 14 with a receptacle 16, visible in the longitudinal section in FIG. 2, that is filled with ion exchanger material 12 and is delimited by a circumferentially extending wall 32. The wall 32 comprises a plurality of outflow ports 18 distributed about its circumference.

The wall 32 is embodied as one piece together with the cover 112 that, as intended, is provided as the cover 112 of the housing 102 of the ion exchanger filter device 100 illustrated in FIGS. 1 and 2 for receiving the ion exchanger cartridge 10.

As seen for example in FIG. 4, the outflow ports 18 of the ion exchanger cartridge 10 are arranged in an axially upper quarter of the receptacle 16. Furthermore, screen fabric 30 is arranged in the receptacle 16 in front of the outflow ports 18 of the ion exchanger cartridge 10 in order to enable the flow of the medium to exit from the cartridge container 14 and to retain the loose fill of the ion exchanger material 12 at the same time.

The cover 112 comprises an overlap region 24, for example a connection section 28 with a thread section for connection to the housing 102 of the ion exchanger filter device 100, which in axial direction L at least overlaps the wall 32.

Since the overlap region 24 is arranged at a distance to the wall 32 of the cartridge container 14, between the overlap region 24 and the wall 32 a gap 26, for example an annular gap, is formed. The outflow ports 18 are arranged in the region of the wall 32 that is overlapped by the overlap 24, i.e., in the region of the gap 26. In this way, a flow path 50 of a medium through the ion exchanger cartridge 10 downstream of the outflow ports 18 comprises a deflection 52 within the gap 26. The deflection 52 of the flow upon entry in the annular gap 26 acts in this context in a homogenizing manner on the flow so that the entire ion exchanger resin is used up uniformly and no dead spaces are formed in relation to the flow.

That which is claimed is:

1. An ion exchanger cartridge comprising:
a cartridge container comprising a receptacle, wherein the receptacle is delimited by a circumferentially extending wall comprising one or more outflow ports distributed at an outer circumference of the circumferentially extending wall, wherein the receptacle is filled with an ion exchanger material;
a cover coupled with the cartridge container and comprising an overlap region overlapping the one or more outflow ports and the circumferentially extending wall in an axial direction of the ion exchanger cartridge at a radially outer distance from the circumferentially extending wall, the overlap region forming an annular gap with the one or more outflow ports arranged radially and axially within the annular gap of the overlap region; and
wherein a flow path of a medium through the ion exchanger cartridge comprises a first flow direction in the axial direction to the one or more outflow ports, and a deflection downstream of the one or more outflow ports and within the annular gap to a second flow direction of the flow path of the medium in the axial direction opposite to the first flow direction.

2. The ion exchanger cartridge according to claim 1, wherein the overlap region is embodied as a connection section configured to connect the cover of the ion exchanger cartridge to a housing of an ion exchanger filter device.

3. The ion exchanger cartridge according to claim 2, wherein the connection section is a thread section.

4. The ion exchanger cartridge according to claim 3, wherein the thread section of the connection section of the overlap region comprises an outer thread.

5. The ion exchanger cartridge according to claim 1, wherein the annular gap extends continuously about the outer circumference of the circumferentially extending wall such that the medium exiting the one or more outflow ports is collected circumferentially before being guided in the second flow direction.

6. The ion exchanger cartridge according to claim 1, wherein the one or more outflow ports are arranged in an upper quarter of the receptacle.

7. The ion exchanger cartridge according to claim 1, wherein the one or more outflow ports are covered by a screen fabric configured to retain the ion exchanger material within the receptacle.

8. The ion exchanger cartridge according to claim 1, further comprising at least one circumferentially extending seal arranged at an axial end region of the ion exchanger cartridge.

9. The ion exchanger cartridge according to claim 8, wherein the at least one circumferentially extending seal is a seal that seals in at least a radial direction.

10. The ion exchanger cartridge according to claim 1, wherein the ion exchanger material is a loose fill.

11. The ion exchanger cartridge according to claim 1, wherein the deflection of the flow path occurs at an inner side of the cover such that the medium impinges on the inner side of the cover after exiting the one or more outflow ports and is redirected into the annular gap in the second flow direction in the axial direction opposite to the first flow direction.

12. The ion exchanger cartridge according to claim 1, wherein the cartridge container comprises an inflow end opposite the cover in the axial direction, the inflow end configured for admitting the medium into the receptacle in the first flow direction.

13. The ion exchanger cartridge according to claim 1, wherein the cover and the circumferentially extending wall of the receptacle are formed as a single component.

14. An ion exchanger filter device comprising:
a housing comprising an inflow opening and an outflow opening for a medium, wherein the outflow opening penetrates an outer jacket wall of the housing;
an ion exchanger cartridge arranged in the housing, wherein a flow path for the medium extends from the inflow opening of the housing through the ion exchanger cartridge in a first flow direction, and to the outflow opening of the housing in a second flow direction opposite the first flow direction, and then through the outflow opening in a radial direction relative to an axial direction of the ion exchanger cartridge;
wherein the ion exchanger cartridge comprises a cartridge container comprising a receptacle, wherein the receptacle is delimited by a circumferentially extending wall comprising one or more outflow ports distributed at an outer circumference of the circumferentially extending wall, and wherein a cover for the housing is coupled with the ion exchanger cartridge;
wherein the receptacle is filled with an ion exchanger material;
wherein the one or more outflow ports, in relation to the outflow opening of the housing, are arranged offset in the axial direction; and
wherein the flow path comprises a deflection of the flow path adjacent the one or more outflow ports from the first flow direction to the second flow direction.

15. The ion exchanger filter device according to claim 14, wherein the cover comprises an overlap region which overlaps the circumferentially extending wall in the axial direction at a radially outer distance from the circumferentially extending wall to form an annular gap with the one or more outflow ports arranged radially and axially within the annular gap, such that the medium flows from the first flow direction through the one or more outflow ports to the deflection of the flow path at an inner side of the cover and is guided along the annular gap in the second flow direction to the outflow opening of the housing.

16. The ion exchanger filter device according to claim 14, wherein the outflow opening is arranged in an upper third of a housing height of the housing and the one or more outflow ports are arranged axially between the cover and the outflow opening.

17. The ion exchanger filter device according to claim 14, wherein the one or more outflow ports are arranged in the axial direction in an upper quarter of the receptacle.

18. The ion exchanger filter device according to claim 14, wherein the one or more outflow ports are covered by a screen fabric.

19. The ion exchanger filter device according to claim 14, wherein the housing comprises an inflow socket arranged in a lower third of a housing height of the housing.

20. The ion exchanger filter device according to claim 14, wherein the ion exchanger cartridge comprises at least one circumferentially extending seal arranged at an axial end region of the receptacle, and wherein the at least one circumferentially extending seal is a seal that seals in at least the radial direction.
